(19) United States
(12) Patent Application Publication
(10) Pub. No.: US 2026/0279643 A1
(43) Pub. Date: Sep. 17, 2026

(54) MAGNETIC COMPONENT, INTEGRATED MAGNETIC DEVICE, AND THREE-PHASE CONVERTER

(71) Applicant: Delta Electronics (Shanghai) Co., Ltd., Shanghai (CN)

(72) Inventors: Tongmin LIU, Shanghai (CN); Ge TANG, Shanghai (CN); Xiaolei WANG, Shanghai (CN)

(21) Appl. No.: 19/452,916

(22) Filed: Jan. 20, 2026

(30) Foreign Application Priority Data
Mar. 17, 2025 (CN) 202510320455.X

(51) Int. Cl. H01F 27/24; H01F 27/22; H01F 27/28

(52) U.S. Cl. CPC H01F 27/24; H01F 27/22; H01F 27/28

(57) ABSTRACT

The present application provides a magnetic component, an integrated magnetic device and a three-phase converter. The magnetic component includes first to fourth side legs. The first side leg is located between a first center leg and a second center leg, and a side of the part of the first side leg away from the third center leg, respectively. The second side leg is located between the second center leg and the third center leg, and a side of the part of the second side leg away from the first center leg, respectively. A part of the third side leg located at the second side of the first center leg, and a part of the fourth side leg located at a first side of the third center leg.

### CROSS-REFERENCE TO RELATED APPLICATION

This application claims priority to Chinese Patent Application No. 202510320455.X, filed on Mar. 17, 2025, which is hereby incorporated by reference in its entirety.

### TECHNICAL FIELD

The present application relates to the field of electrical equipment technology, in particular, to a magnetic component, an integrated magnetic device, and a three-phase converter.

### BACKGROUND

A three-phase converter includes a first-side circuit, a second-side circuit and a magnetic component. The magnetic component is electrically connected to the first-side circuit and the second-side circuit. The three-phase converter, due to an interleaved operation of its three-phase bridge arms, exhibits small input and output current ripples. This makes it suitable for high-power environments and thus widely used.

In conventional approaches, in order to increase power density, magnetic components in the three-phase converter can be integrated into a monolithic integrated magnetic device through magnetic integration techniques. However, these magnetic components in the related art suffer from the problem of high magnetic core losses.

### SUMMARY

In order to overcome the above defects in the related art, the objective of the present application is to provide a magnetic component, an integrated magnetic device and a three-phase converter, for reducing magnetic core losses of the magnetic component.

In an aspect, the present application provides a magnetic component, including a first core plate and a second core plate arranged oppositely, where a first center leg, a second center leg and a third center leg are arranged between the first core plate and the second core plate, and along a second direction, the second center leg is placed between the first center leg and the third center leg, where the first center leg is wound around a first winding, the second center leg is wound around a second winding, and the third center leg is wound around a third winding;
the magnetic component further includes a plurality of side legs connecting the first core plate and the second core plate, where the plurality of side legs include a first side leg, a second side leg, a third side leg, and a fourth side leg; along a first direction, the first side leg and the second side leg are located at a first side of the first winding, the second winding and the third winding; where the third side leg and the fourth side leg are located at a second side of the first winding, the second winding and the third winding;
along the second direction, a first side of the first center leg is close to the third center leg, and a second side of the first center leg is away from the third center leg; a first side of the third center leg is away from the first center leg, and a second side of the third center leg is close to the first center leg; where the first side leg and the second side leg are arranged at intervals, a part of the first side leg is located between the first center leg and the second center leg, while another part of the first side leg is located at a side of the part of the first side leg away from the third center leg; where a part of the second side leg is located between the second center leg and the third center leg, while another part of the second side leg is located at a side of the part of the second side leg away from the first center leg; where the third side leg and the fourth side leg are arranged at intervals, with at least part of the third side leg located at the second side of the first center leg, and at least part of the fourth side leg located at the first side of the third center leg.

In another aspect, the present application provides an integrated magnetic device, including the magnetic components described above and a third core plate. The third core plate is located between the first core plate and the second core plate. The first winding includes a first upper winding and a first lower winding, the first upper winding and the first lower winding are located at a first side and a second side of the third core plate respectively. The second winding includes a second upper winding and a second lower winding, the second upper winding and the second lower winding are located at the first side and the second side of the third core plate respectively. The third winding includes a third upper winding and a third lower winding, the third upper winding and the third lower winding are located at the first side and the second side of the third core plate respectively.

In another aspect, the present application provides an integrated magnetic device, including the magnetic components described above and a third core plate. The third core plate is located between the first core plate and the second core plate. The first winding includes a first transformer winding and a first inductance winding, the first transformer winding and the first inductance winding are located at a first side and a second side of the third core plate respectively. The second winding includes a second transformer winding and a second inductance winding, the second transformer winding and the second inductance winding are located at the first side and the second side of the third core plate respectively. The third winding includes a third transformer winding and a third inductance winding, the third transformer winding and the third inductance winding are located at the first side and the second side of the third core plate respectively;
the first side leg includes a first upper side leg and a first lower side leg, the second side leg includes a second upper side leg and a second lower side leg, the third side leg includes a third upper side leg and a third lower side leg, and the fourth side leg includes a fourth upper side leg and a fourth lower side leg, where the first upper side leg, the second upper side leg, the third upper side leg, and the fourth upper side leg are connected to the first core plate and the third core plate, the first lower side leg, the second lower side leg, the third lower side leg, and the fourth lower side leg are connected to the third core plate and the second core plate;
the first upper side leg, the second upper side leg, the third upper side leg, the fourth upper side leg, the first core plate, the third core plate, the first transformer winding, the second transformer winding, and the third transformer winding together form a transformer; and the first lower side leg, the second lower side leg, the third lower side leg, the fourth lower side leg, the third core plate, the second core plate, the first inductor winding, the second inductor winding, and the third inductor winding together form an inductor.

In another aspect, the present application provides a three-phase converter including a first-side circuit and a second-side circuit. The three-phase converter further includes a magnetic component or an integrated magnetic device, where the magnetic component or the integrated magnetic device is electrically connected between the first-side circuit and the second-side circuit, where the magnetic component is the magnetic components described above, and the integrated magnetic device is the integrated magnetic devices described above.

The present application provides a magnetic component, an integrated magnetic device, and a three-phase converter. In the present application, the structural design of the side legs achieves a more uniform distribution of magnetic flux in the center legs. This design also enhances the magnetic circuit coupling of the magnetic flux in the center legs in the core plates, improves the magnetic flux cancellation effect and thereby reduces the magnetic core losses of the magnetic component.

### BRIEF DESCRIPTION OF DRAWINGS

In order to more clearly illustrate technical solutions in embodiments of the present application or in the prior art, a brief introduction of drawings required to be used in the description of the embodiments or the prior art is provided below. It is obvious that the drawings described below are some embodiments of the present application. For ordinary person skilled in the art, other drawings can also be obtained according to these drawings without paying creative labor.

FIG. 1 is a circuit schematic diagram of a three-phase converter.

FIG. 2 is a simplified structural diagram of an integrated magnetic device in the related art.

FIG. 3 is a simplified structural diagram of a magnetic component in the related art.

FIG. 4 is a diagram showing magnetic flux values at certain positions on an integrated magnetic device in the related art.

FIG. 5 is a cross-sectional view of a magnetic component provided by an embodiment of the present application.

FIG. 6 is a diagram showing magnetic circuits formed by a first winding in the magnetic component of FIG. 5.

FIG. 7 is a diagram showing magnetic circuits formed by a second winding in the magnetic component of FIG. 5.

FIG. 8 is a diagram showing magnetic circuit formed by a third winding in the magnetic component of FIG. 5.

FIG. 9 is a diagram showing magnetic circuits of the magnetic component of FIG. 5.

FIG. 10 is a cross-sectional view of a magnetic component provided by another embodiment of the present application.

FIG. 11 is a cross-sectional view of a magnetic component provided by another embodiment of the present application.

FIG. 12 is a cross-sectional view of a magnetic component provided by another embodiment of the present application.

FIG. 13 is a cross-sectional view of a magnetic component provided by another embodiment of the present application.

FIG. 14 is a simplified structural diagram of an integrated magnetic device provided by an embodiment of the present application.

FIG. 15 is a sectional view along A-A of FIG. 14.

FIG. 16 is a simplified structural diagram of an integrated magnetic device provided by another embodiment of the present application.

FIG. 17 is a sectional view along B-B of FIG. 16.

FIG. 18 is a simplified structural diagram of an integrated magnetic device provided by another embodiment of the present application.

FIG. 19 is a sectional view along C-C of FIG. 18.

FIG. 20 is a simplified structural diagram of an integrated magnetic device provided by another embodiment of the present application.

FIG. 21 is a sectional view along D-D of FIG. 20.

FIG. 22 is a simplified structural diagram of an integrated magnetic device provided in another embodiment of the present application.

FIG. 23 is a sectional view along E-E of FIG. 22.

FIG. 24 is a diagram showing magnetic flux values at certain positions on an integrated magnetic device provided by an embodiment of the present application.

FIG. 25 is a diagram showing magnetic flux values at certain positions on an integrated magnetic device provided by another embodiment of the present application.

### REFERENCE SIGNS

10—magnetic component;
20—first-side circuit;
30—second-side circuit;
110—first center leg; 120—second center leg; 130—third center leg;
210—first winding; 220—second winding; 230—third winding;
310—first side leg; 311—first sub-side leg; 312—second sub-side leg; 320—second side leg; 321—third sub-side leg; 322—fourth sub-side leg; 330—third side leg; 340—fourth side leg; 350—fifth side leg;
410—first heatsink; 411—first sub-heatsink; 412—second sub-heatsink; 420—second heatsink; 421—third sub-heatsink; 422—fourth sub-heatsink; 430—third heatsink; 431—fifth sub-heatsink; 432—sixth sub-heatsink; 433—seventh sub-heatsink; 440—fourth heatsink; 441—eighth sub-heatsink; 442—ninth sub-heatsink; 443—tenth sub-heatsink;
510—first core plate; 520—second core plate; 530—third core plate;
X-first direction; Y-second direction; Z-third direction.

### DESCRIPTION OF EMBODIMENTS

To make the objectives, technical solutions, and advantages of the present application clearer, the following will provide a clear and complete description of the technical solutions in the embodiments of the present application with reference to the drawings in embodiments of the present application. It should be obvious that the described embodiments are only a part of the embodiments of the present application, not all of embodiments.

Based on the embodiments of the present application, all other embodiments obtained by those of ordinary skill in the art without paying creative labor are within the protection scope of the present application. Where there is no conflict, the embodiments and features described below can be combined with each other.

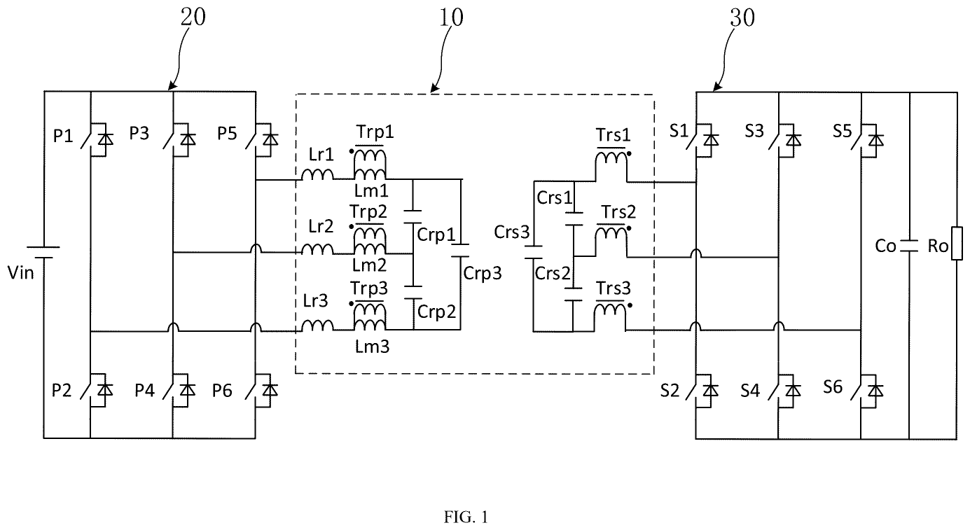

FIG. 1 is a circuit schematic diagram of a three-phase converter. As shown in FIG. 1, the three-phase converter includes a first-side circuit 20, a second-side circuit 30, and a magnetic component 10. The magnetic component 10 is electrically connected between the first-side circuit 20 and the second-side circuit 30. Specifically, the first-side circuit 20 includes a plurality of switching transistors (such as P1-P6 in FIG. 1). A fifth switching transistor P5 and a sixth switching transistor P6 are connected in series to form a first bridge arm of a primary circuit. A third switching transistor P3 and a fourth switching transistor P4 are connected in series to form a second bridge arm of the primary circuit. A first switching transistor P1 and a second switching transistor P2 are connected in series to form a third bridge arm of the primary circuit. Similarly, the second-side circuit 30 also includes a plurality of switching transistors (such as S1-S6 in FIG. 1). The switching transistors are connected in pairs to form a first bridge arm of a secondary circuit, a second bridge arm of the secondary circuit, and a third bridge arm of the secondary circuit, respectively. The magnetic component 10 includes a first primary winding, a second primary winding, a third primary winding, a first secondary winding, a second secondary winding, and a third secondary winding. The first bridge arm of the primary circuit is connected to the first bridge arm of the secondary circuit through the first primary winding and the first secondary winding. The second bridge arm of the primary circuit is connected to the second bridge arm of the secondary circuit through the second primary winding and the second secondary winding. The third bridge arm of the primary circuit is connected to the third bridge arm of the secondary circuit through the third primary winding and the third secondary winding.

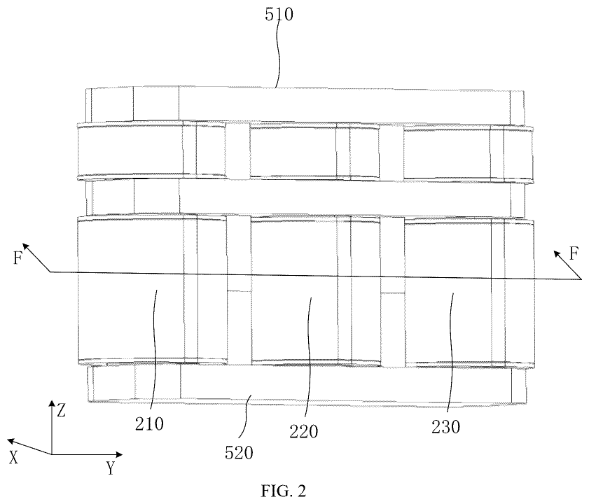

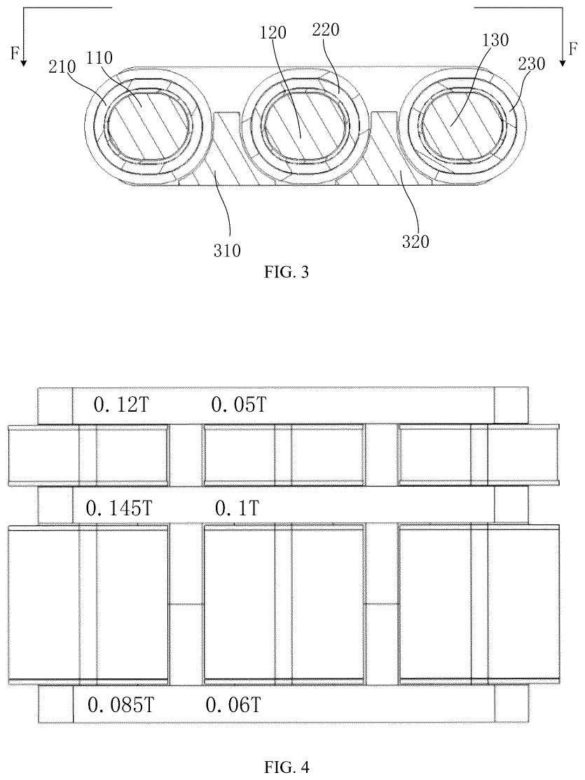

As described in the background, the magnetic component in the related art suffers from the problem of high magnetic core losses. As shown in FIG. 2 and FIG. 3, FIG. 3 is a sectional view along F-F of FIG. 2. Specifically, the magnetic component in the related art includes a first core plate 510 and a second core plate 520, as well as a first center leg 110, a second center leg 120, and a third center leg 130 located between the first core plate 510 and the second core plate 520. The first center leg 110 is wound around a first winding 210 (including the first primary winding and/or the first secondary winding, hereinafter the same), the second center leg 120 is wound around a second winding 220 (including the second primary winding and/or the second secondary winding, hereinafter the same), and the third center leg 130 is wound around a third winding 230 (including the third primary winding and/or the third secondary winding, hereinafter the same). The magnetic component also includes a plurality of side legs connecting the first core plate 510 and the second core plate 520. In the scheme of the related art, there are two side legs. For ease of description, the two side legs include a first side leg 310 and a second side leg 320. Along a first direction X, the first side leg 310 and the second side leg 320 are located at a first side of the first winding 210, the second winding 220, and the third winding 230. Along a second direction Y, the first side leg 310 is located between the first winding 210 and the second winding 220, and the second side leg 320 is located between the second winding 220 and the third winding 230.

During operation of the magnetic component, most of magnetic circuits of the first winding 210 travel from the first center leg 110 to the first core plate 510, then pass through the side legs and the second core plate 520 and return back to the first center leg 110. A majority of these magnetic circuits pass through the first side leg 310 which is closer to the first winding 210, and a smaller portion of these magnetic circuits pass through the second side leg 320 which is farther away. Correspondingly, most of magnetic circuits of the third winding 230 travel from the third center leg 130 to the first core plate 510, then pass through the side legs and the second core plate 520 and return back to the third center leg 130. A majority of these magnetic circuits pass through the second side leg 320 which is closer to the third winding 230, and a smaller portion of these magnetic circuits pass through the first side leg 310 which is farther away. It can be understood that, due to the arrangement of the side legs, the distribution of magnetic circuits within the magnetic component in the related art is uneven. The magnetic coupling between the magnetic circuits of the first winding 210 and the third winding 230 is weak, resulting in poor magnetic flux cancellation. Therefore, the magnetic core losses of the magnetic component are relatively high.

Table 1 shows results of magnetic core losses of the magnetic component in the related art.

TABLE 1

| | The number of turns of the resonant | | | |
|---|---|---|---|---|
| | inductor (Nr) = 8; | | | |
| | Primary winding (Np): | | | |
| | Secondary winding (Ns) = | | | |
| | 12:6 (0.05*1200) | | | |
| | Output voltage 820 V | | | |
| | Input voltage 460 V | | Output voltage 680 V | |
| | (delay) | | Input voltage 275 V | |
| Resonant inductor | 18.238 | W | 28.694 | W |
| winding loss (Lr_W) | | | | |
| Resonant inductor core | 9.0504 | W*1.5 | 14.3516 | W*1.5 |
| loss (Lr_Core) | | | | |
| Transformer winding | 39.103 | W | 65.71 | W |
| loss (Tx_W) | | | | |
| Transformer core loss | 15.2723 | W*1.5 | 10.2918 | W*1.5 |
| (Tx_Core) | | | | |
| Total | 93.826 | W | 131.46 | W |

As can be seen from Table 1 and FIG. 4, the magnetic core losses of the magnetic component in the related art are relatively high, and the magnetic core losses of a corresponding integrated magnetic device are also high.

In addition, in the scheme of the related art, a heat source of the magnetic component is mainly positioned at the second center leg 120 and the second winding 220, resulting in poor heat dissipation.

In view of this, embodiments of the present application provide a magnetic component, an integrated magnetic device, and a three-phase converter. A first side leg and a second side leg are arranged at intervals. A part of the first side leg is located between a first center leg and a second center leg, while the other part of the first side leg is located at a side of the part of the first side leg away from a third center leg. A part of the second side leg is located between the second center leg and the third center leg, while the other part of the second side leg is located at a side of the part of the second side leg away from the first center leg. The third side leg and the fourth side leg are arranged at intervals, with at least part of the third side leg located at a second side of the first center leg, and at least part of the fourth side leg located at a first side of the third center leg. The aforementioned arrangement achieves a more uniform distribution of magnetic flux in the center legs, enhances the magnetic circuit coupling of the magnetic flux in the center legs in the core plates, improves the magnetic flux cancellation effect and thereby reduces the magnetic core losses of the magnetic component.

In the following, a description of the embodiments of the present application will be provided in combination with the drawings to enable ordinary persons skilled in the art to gain a more comprehensive understanding of the present application. It should be noted that in the description of the embodiments of the present application, a first direction X, a second direction Y, and a third direction Z represent three different directions in a three-dimensional space, for example, the first direction X, the second direction Y, and the third direction Z can be perpendicular to each other.

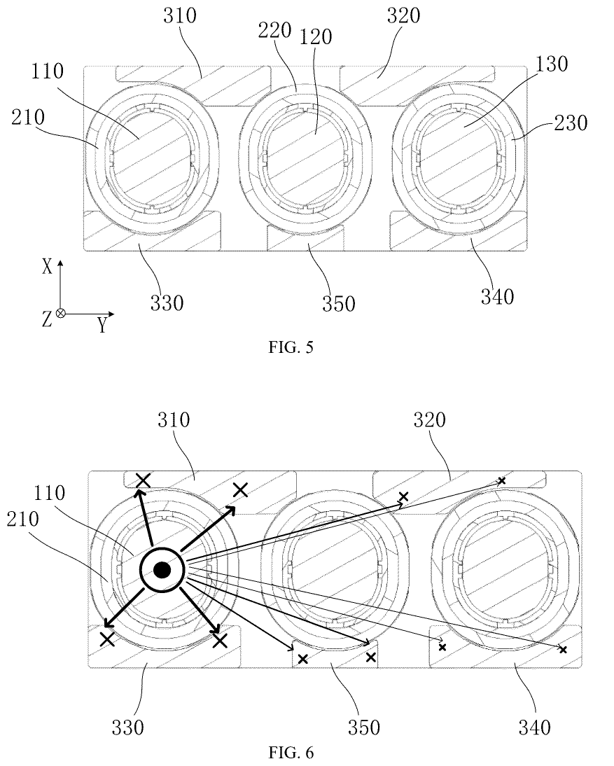

Referring to FIG. 5 to FIG. 13, a magnetic component is provided in an embodiment. The magnetic component includes a first core plate and a second core plate (not shown in figures) arranged oppositely. For example, the first core plate and the second core plate may be arranged oppositely along the third direction Z. A first center leg 110, a second center leg 120 and a third center leg 130 are placed between the first core plate and the second core plate. Two ends of each of the first center leg 110, the second center leg 120 and the third center leg 130 are respectively connected to the first core plate and the second core plate. The first center leg 110 is wound around a first winding 210, the second center leg 120 is wound around a second winding 220, and the third center leg 130 is wound around a third winding 230.

The magnetic component further includes a plurality of side legs connecting the first core plate and the second core plate. The plurality of side legs include a first side leg 310, a second side leg 320, a third side leg 330, and a fourth side leg 340. Along a first direction X, the first side leg 310 and the second side leg 320 are located at a first side of the first winding 210, the second winding 220, and the third winding 230 (i.e., the upper side of the figures). The third side leg 330 and the fourth side leg 340 are located at a second side of the first winding 210, the second winding 220, and the third winding 230 (i.e., the lower side of the figures).

Continue to refer to FIG. 5 and FIG. 10 to FIG. 13, along the second direction Y, a first side of the first center leg 110 is close to the third center leg 130, and a second side of the first center leg 110 is away from the third center leg 130. That is, the first side of the first center leg 110 is the right side of the first center leg 110 in a horizontal direction as shown in the figures, and the second side of the first center leg 110 is the left side of the first center leg 110 in the horizontal direction as shown in the figures. A first side of the third center leg 130 is away from the first center leg 110, and a second side of the third center leg 130 is close to the first center leg 110. That is, the first side of the third center leg 130 is the right side of the third center leg 130 in the horizontal direction as shown in the figures, and the second side of the third center leg 130 is the left side of the third center leg 130 in the horizontal direction as shown in the figures. And along the second direction Y, the second center leg 120 is placed between the first center leg 110 and the third center leg 130.

The first side leg 310 and the second side leg 320 are arranged at intervals (that is, a gap is formed between them in the horizontal direction). A part of the first side leg 310 is located between a first center leg 110 and the second center leg 120, while the other part of the first side leg 310 is located at a side of the part of the first side leg 310 away from the third center leg 130, i.e., the other part of the first side leg 310 is located at the left side of the part of the first side leg 310 which is located between a first center leg 110 and the second center leg 120, in the horizontal direction as shown in the figures. A part of the second side leg 320 is located between the second center leg 120 and the third center leg 130, while the other part of the second side leg 320 is located at a side of the part of the second side leg 320 away from the first center leg 110, i.e., the other part of the second side leg 320 is located at right side of the part of the second side leg 320 which is located between the second center leg 120 and the third center leg 130, in the horizontal direction as shown in the figures.

The third side leg 330 and the fourth side leg 340 are arranged at intervals (that is, a gap is formed between them in the horizontal direction), with at least part of the third side leg 330 located at the second side of the first center leg 110 (i.e., the left side of the figures), and at least part of the fourth side leg 340 located at the first side of the third center leg 130 (i.e., the right side of the figures).

In the embodiment, magnetic circuits formed by the first winding 210, the second winding 220, and the third winding 230 can start from their respective center legs to the first core plate, pass through the first side leg 310, the second side leg 320, the third side leg 330, and the fourth side leg 340, and then reach the second core plate, finally return from the second core plate to their respective center legs.

Continue to refer to FIG. 6 to FIG. 9, specifically, FIG. 6 shows a diagram of magnetic circuits formed by the first winding 210. The thickness of a line indicates the magnetic intensity of the magnetic circuit. Apparently, the magnetic intensity of the magnetic circuits formed by the first winding 210 is relatively strong at the first side leg 310 and the third side leg 330, which are closer to the first winding 210, and relatively weak at the second side leg 320 and the fourth side leg 340, which are farther from the first winding 210. That is, the farther away from the first winding 210, the weaker the magnetic intensity of the magnetic circuit strength is.

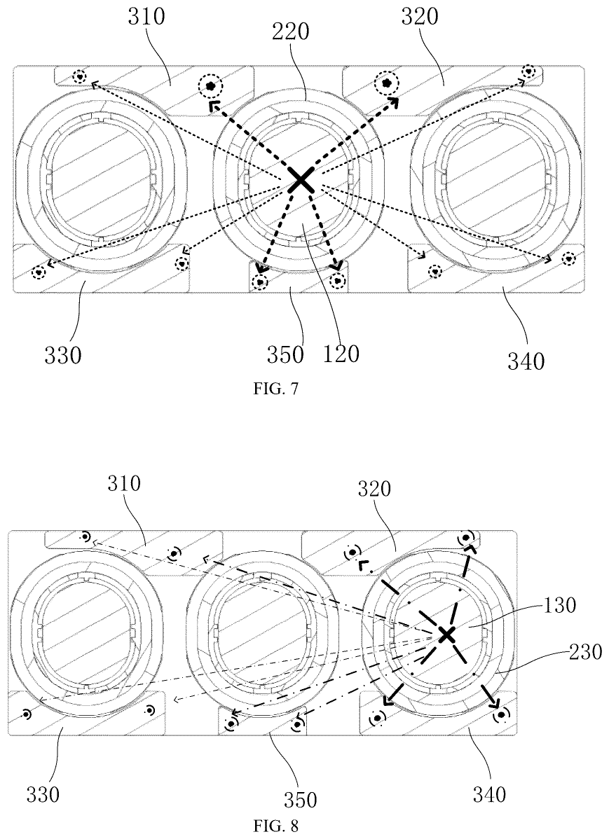

FIG. 7 shows a diagram of magnetic circuits formed by the second winding 220. The thickness of a line indicates the strength of the magnetic intensity of the magnetic circuit. Apparently, since the second winding 220 is located in the middle of the magnetic component, the magnetic circuits formed by the second winding 220 have a uniform distribution at the first side leg 310, the second side leg 320, the third side leg 330, and the fourth side leg 340.

FIG. 8 shows a diagram of magnetic circuits formed by the third winding 230. The thickness of a line indicates the strength of the magnetic intensity of the magnetic circuit. Apparently, the magnetic intensity of the magnetic circuits formed by the third winding 230 are relatively strong at the second side leg 320 and the fourth side leg 340, which are closer to the third winding 230, and relatively weak at the first side leg 310 and the third side leg 330, which are farther from the third winding 230. That is, the farther away from the third winding 230, the weaker the magnetic intensity of the magnetic circuit strength becomes.

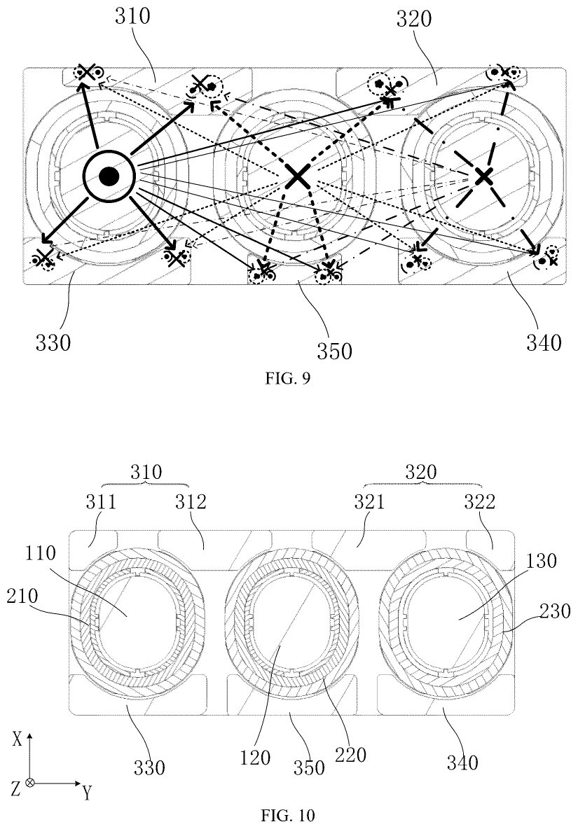

FIG. 9 shows a diagram of magnetic circuit coupling in the magnetic component. Apparently, magnetic circuits can be uniformly distributed throughout the magnetic component with the structure described in the aforementioned embodiment. Besides, the magnetic circuits formed by the first winding 210 to the third winding 230 can be coupled with each other at the first core plate and/or the second core plate after passing through the first side leg 310, the second side leg 320, the third side leg 330, and the fourth side leg 340, achieving magnetic flux cancellation and thereby reducing the magnetic core losses of the magnetic component. At the same time, this structure also ensures a more uniform distribution of magnetic flux in the first center leg 110 to the third center leg 130.

It should be noted that the magnetic component of the embodiment can be a transformer composed of the primary winding connected to the first-side circuit 20, the secondary winding connected to the second-side circuit 30 and the magnetic core, or, it can be a resonant inductor in the first-side circuit 20.

According to the above description of the embodiment, the structural design of the side legs achieves a more uniform distribution of magnetic flux in the center legs. This design also enhances the magnetic circuit coupling of the magnetic flux in the center legs in the core plates, improves the magnetic flux cancellation effect and thereby reduces the magnetic core losses of the magnetic component.

Continue to refer to FIG. 5 and FIG. 12, in some possible implementations, along the second direction Y, the first end of the first side leg 310 (that is, the right end of the first side leg 310 in the horizontal direction as shown in the figures) is close to the second center leg 120. The second end of the first side leg 310 (that is, the left end of the first side leg 310 in the horizontal direction as shown in the figures) extends to an end of the first center leg 110 away from the third center leg 130 (that is, the left end of the first center leg 110 in the horizontal direction as shown in the figures).

Alternatively, based on FIG. 5 and FIG. 12, the second end of the first side leg 310 can be further extends to the second side of the first center leg 110. This further facilitates the uniform distribution of the magnetic circuits formed by the windings throughout the magnetic component, thereby improving the magnetic flux cancellation effect and reducing the magnetic core losses of the magnetic component.

Similarly, along the second direction Y, the second end of the second side leg 320 (that is, the left end of the second side leg 320 in the horizontal direction as shown in the figures) is close to the second center leg 120. The first end of the second side leg 320 (that is, the right end of the second side leg 320 in the horizontal direction as shown in the figures) extends to an end of the third center leg 130 (that is, the right end of the third center leg 130 in the horizontal direction as shown in the figures).

Alternatively, based on FIG. 5 and FIG. 12, the first end of the second side leg 320 can be further extends to the first side of the third center leg 130. This further facilitates the uniform distribution of the magnetic circuits formed by the windings throughout the magnetic component, thereby improving the magnetic flux cancellation effect and reducing the magnetic core losses of the magnetic component.

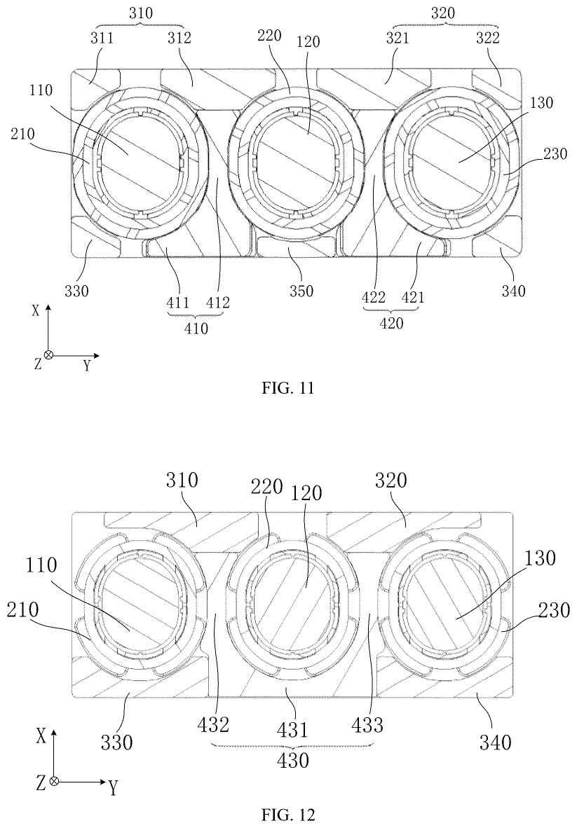

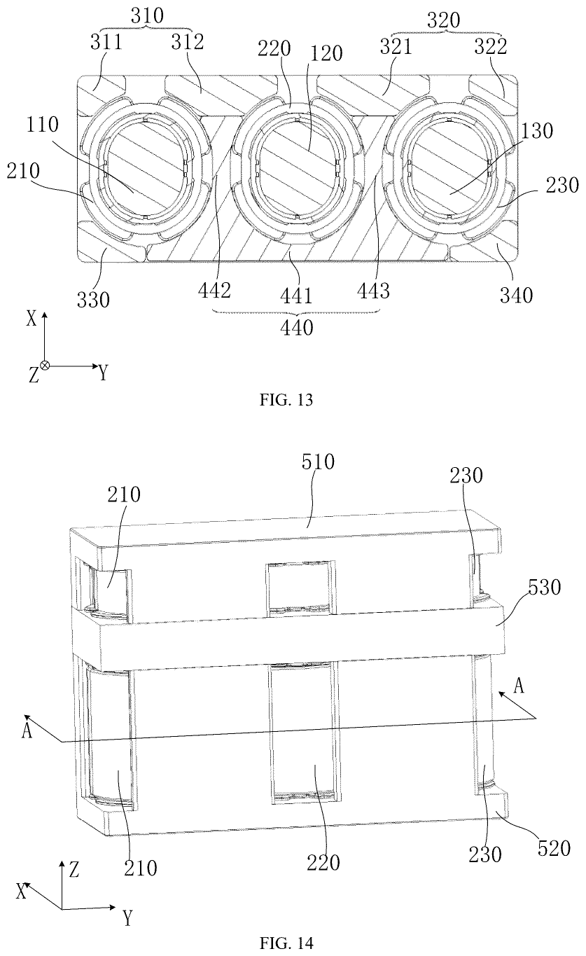

As shown in FIG. 10, FIG. 11 and FIG. 13, in some possible implementations, the first side leg 310 includes a first sub-side leg 311 and a second sub-side leg 312. The first sub-side leg 311 and the second sub-side leg 312 are arranged at intervals (that is, a gap is formed between them in the horizontal direction) along the second direction Y. Along the second direction Y, the second sub-side leg 312 is at least located between the first center leg 110 and the second center leg 120, and the first sub-side leg 311 is located at the second side of the first center leg 110. This arrangement of the first sub-side leg 311 further facilitates the uniform distribution of the magnetic circuits formed by the windings throughout the magnetic component, thereby improving the magnetic flux cancellation effect and reducing the magnetic core losses of the magnetic component.

The second side leg 320 includes a third sub-side leg 321 and a fourth sub-side leg 322. The third sub-side leg 321 and the fourth sub-side leg 322 are arranged at intervals (that is, a gap is formed between them in the horizontal direction) along the second direction Y. Along the second direction Y, the third sub-side leg 321 is at least located between the second center leg 120 and the third center leg 130, and the fourth sub-side leg 322 is located at the first side of the third center leg 130. This arrangement of the fourth sub-side leg 322 further facilitates the uniform distribution of the magnetic circuits formed by the windings throughout the magnetic component, thereby improving the magnetic flux cancellation effect and reducing the magnetic core losses of the magnetic component.

Continue to refer to FIG. 5 to FIG. 10, in some possible implementations, the magnetic component further includes a fifth side leg 350. Along the second direction Y, the third side leg 330, the fourth side leg 340, and the fifth side leg 350 are arranged at intervals. That is, there is a gap between every two adjacent side legs among the third side leg 330, the fourth side leg 340 and the fifth side leg 350.

Along the first direction X, the fifth side leg 350 is located at the second side of the first winding 210, the second winding 220, and the third winding 230. In a plane perpendicular to the first direction X, a projection of the third side leg 330 is within a projection range of the first winding 210, a projection of the fifth side leg 350 is within a projection range of the second winding 220, and a projection of the fourth side leg 340 is within a projection range of the third winding 230. That is, in the second direction Y, the maximum length of the first winding 210 is greater than or equal to the maximum length of the third side leg 330, the maximum length of the second winding 220 is greater than or equal to the maximum length of the fifth side leg 350, and the maximum length of the third winding 230 is greater than or equal to the maximum length of the fourth side leg 340.

The aforementioned arrangement of the fifth side leg 350 in the embodiment further facilitates the uniform distribution of the magnetic circuits formed by the windings throughout the magnetic component, thereby improving the magnetic flux cancellation effect and reducing the magnetic core losses of the magnetic component.

As shown in FIG. 11, in some possible implementations, the magnetic component further includes a fifth side leg 350. Along the second direction Y, the third side leg 330, the fourth side leg 340, and the fifth side leg 350 are arranged at intervals. That is, there is a gap between every two adjacent side legs among the third side leg 330, the fourth side leg 340 and the fifth side leg 350. The third side leg 330 is located at the second side of the first center leg 110, and the fourth side leg 340 is located at the first side of the third center leg 130.

Along the first direction X, the fifth side leg 350 is located at the second side of the first winding 210, the second winding 220 and the third winding 230, and in a plane perpendicular to the first direction X, a projection of the fifth side leg 350 is within a projection range of the second winding 220.

Compared with the embodiments shown in FIG. 5 and FIG. 10, the fifth side leg 350 in the embodiment is slightly shorter in the second direction Y. This creates gaps between the fifth side leg 350 and the third side leg 330, as well as between the fifth side leg 350 and the fourth side leg 340, facilitating the installation of other components.

It can be understood that the arrangement of the fifth side leg 350 in the embodiment further facilitates the uniform distribution of the magnetic circuits formed by the windings throughout the magnetic component, thereby improving the magnetic flux cancellation effect and reducing the magnetic core losses of the magnetic component.

Continue to refer to FIG. 11, the magnetic component in the embodiment further includes a first heatsink 410 and a second heatsink 420. The first heatsink 410 includes a first sub-heatsink 411 and a second sub-heatsink 412. The second sub-heatsink 412 is connected to a first end of the first sub-heatsink 411, the first end of the first sub-heatsink 411 is close to the fifth side leg 350, and the first sub-heatsink 411 and the second sub-heatsink 412 generally form an “L”-shaped cross-section. The second heatsink 420 includes a third sub-heatsink 421 and a fourth sub-heatsink 422. The fourth sub-heatsink 422 is connected to a second end of the third sub-heatsink 421, the second end of the third sub-heatsink 421 is close to the fifth side leg 350, and the third sub-heatsink 421 and the fourth sub-heatsink 422 generally form an “L”-shaped cross-section.

Along the second direction Y, the first sub-heatsink 411 is located between the third side leg 330 and the fifth side leg 350, and the second sub-heatsink 412 is located between the first winding 210 and the second winding 220. The third sub-heatsink 421 is located between the fifth side leg 350 and the fourth side leg 340, and the fourth sub-heatsink 422 is located between the second winding 220 and the third winding 230.

With the structure in the aforementioned embodiment, the second sub-heatsink 412 and the fourth sub-heatsink 422 are used to guide the heat at least from the second center leg 120 and the second winding 220 to the first sub-heatsink 411 and the third sub-heatsink 421, respectively. Then, by connecting the first sub-heatsink 411 and the third sub-heatsink 421 to external heat dissipation devices, the heat can be dissipated quickly, thereby improving the heat dissipation effect of the magnetic component.

Continue to refer to FIG. 12, in some possible implementations, in a plane perpendicular to the first direction X, a projection of the third side leg 330 is within a projection range of the first winding 210, and a projection of the fourth side leg 340 is within a projection range of the third winding 230. Along the second direction Y, a gap is formed between the third side leg 330 and the fourth side leg 340, facilitating the installation of other components.

Continue to refer to FIG. 12, the magnetic component further includes a third heatsink 430. The third heatsink 430 includes a fifth sub-heatsink 431, a sixth sub-heatsink 432, and a seventh sub-heatsink 433. The fifth sub-heatsink 431, the sixth sub-heatsink 432, and the seventh sub-heatsink 433 generally form a “U”-shaped cross-section.

Along the second direction Y, the sixth sub-heatsink 432 and the seventh sub-heatsink 433 are respectively connected to two ends of the fifth sub-heatsink 431. The fifth sub-heatsink 431 is located between the third side leg 330 and the fourth side leg 340, the sixth sub-heatsink 432 is located between the first winding 210 and the second winding 220, and the seventh sub-heatsink 433 is located between the second winding 220 and the third winding 230.

With the structure in the aforementioned embodiment, the sixth sub-heatsink 432 and the seventh sub-heatsink 433 are used to guide the heat at least from the second center leg 120 and the second winding 220 to the fifth sub-heatsink 431. Then, by connecting the fifth sub-heatsink 431 to an external heat dissipation device, the heat can be dissipated quickly, thereby improving the heat dissipation effect of the magnetic component.

Continue to refer to FIG. 13, in some possible implementations, the magnetic component further includes a fourth heatsink 440. The fourth heatsink 440 includes an eighth sub-heatsink 441, a ninth sub-heatsink 442 and a tenth sub-heatsink 443.

Along the second direction Y, the ninth sub-heatsink 442 and the tenth sub-heatsink 443 are respectively connected to the eighth sub-heatsink 441. The eighth sub-heatsink 441 is located between the third side leg 330 and the fourth side leg 340, the ninth sub-heatsink 442 is located between the first winding 210 and the second winding 220, and the tenth sub-heatsink 443 is located between the second winding 220 and the third winding 230. Along the second direction Y, the two ends of the eighth sub-heatsink 441 are extend to the first end of the third side leg 330 and the second end of the fourth side leg 340, respectively. The first end of the third side leg 330 is the right end of the third side leg 330 in the horizontal direction as shown in the figures. The second end of the fourth side leg 340 is the left end of the fourth side leg 340 in the horizontal direction as shown in the figures.

Among them, the third side leg 330 is located at the second side of the first center leg 110, and the fourth side leg 340 is located at the first side of the third center leg 130. In a plane perpendicular to the first direction X, a projection of the eighth sub-heatsink 441 is within a projection range of at least one of the first winding 210 or the third winding 230.

With the structure in the aforementioned embodiment, the ninth sub-heatsink 442 and the tenth sub-heatsink 443 are used to guide the heat at least from the second center leg 120 and the second winding 220 to the eighth sub-heatsink 441. Then, by connecting the eighth sub-heatsink 441 to an external heat dissipation device, the heat can be dissipated quickly, thereby improving the heat dissipation effect of the magnetic component.

Compared with the embodiment shown in FIG. 12, in this embodiment, by shortening the lengths of the third side leg 330 and the fourth side leg 340 in the second direction Y, the gap between the third side leg 330 and the fourth side leg 340 is increased. This increases the length of the eighth sub-heatsink 441 in the second direction Y, thereby enlarging its contact area with the external heat dissipation device and achieving a better heat dissipation effect.

Continue to refer to FIG. 14 to FIG. 23, this embodiment also provides an integrated magnetic device. The integrated magnetic device includes the aforementioned magnetic component and a third core plate 530. The third core plate 530 is located between the first core plate 510 and the second core plate 520, that is, the first core plate 510, the third core plate 530 and the second core plate 520 are arranged at intervals in pairs in the third direction Z. The first winding 210 includes a first upper winding and a first lower winding, the first upper winding and the first lower winding are located at a first side and a second side of the third core plate 530 respectively. For example, the first upper winding can be the first winding 210 located above the third core plate 530 as shown in figures, and the first lower winding can be the first winding 210 located below the third core plate 530 as shown in figures. The second winding 220 includes a second upper winding and a second lower winding, the second upper winding and the second lower winding are located at the first side and the second side of the third core plate 530 respectively. For example, the second upper winding can be the second winding 220 located above the third core plate 530 as shown in figures, and the second lower winding can be the second winding 220 located below the third core plate 530 as shown in figures. The third winding 230 includes a third upper winding and a third lower winding, the third upper winding and the third lower winding are located at the first side and the second side of the third core plate 530 respectively. For example, the third upper winding can be the third winding 230 located above the third core plate 530 as shown in figures, and the third lower winding can be the third winding 230 located below the third core plate 530 as shown in figures.

In the embodiment, the first winding 210, the second winding 220, and the third winding 230 of the integrated magnetic device can all be either transformer windings or inductor windings. That is to say, the integrated magnetic device can include two three-phase transformers or two three-phase inductors formed on both sides of the third core plate 530. Alternatively, the integrated magnetic device can include one three-phase transformer and one three-phase inductor formed on both sides of the third core plate 530.

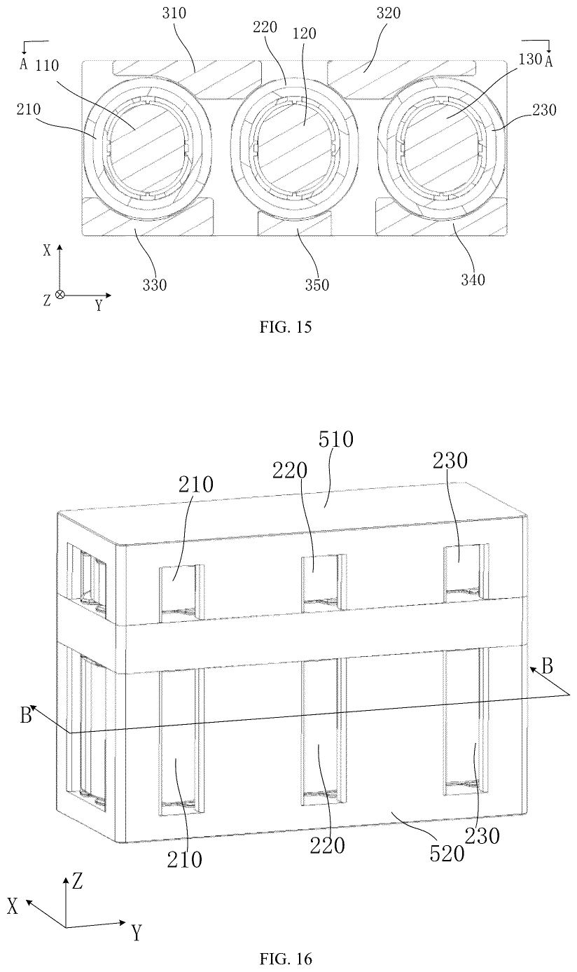

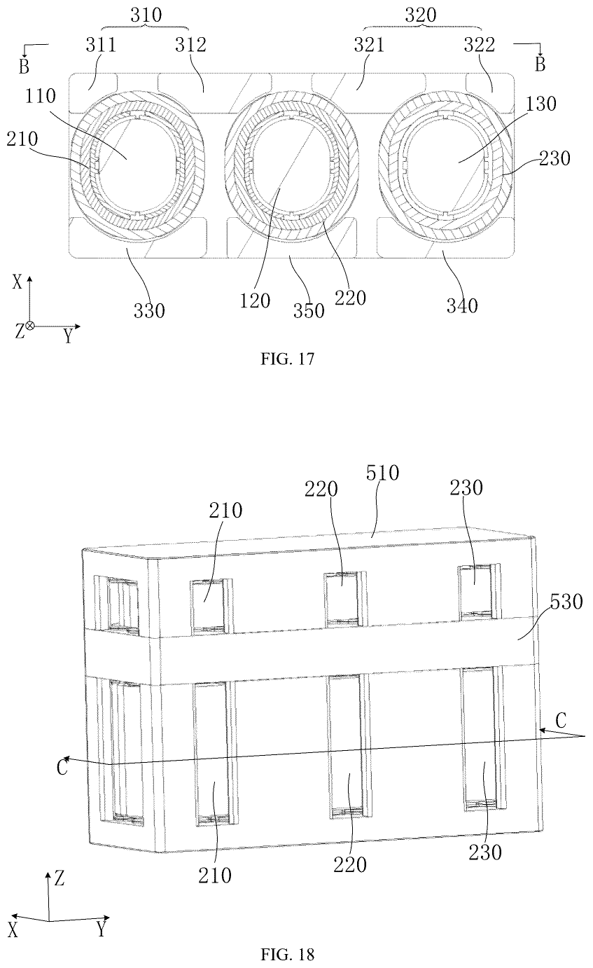

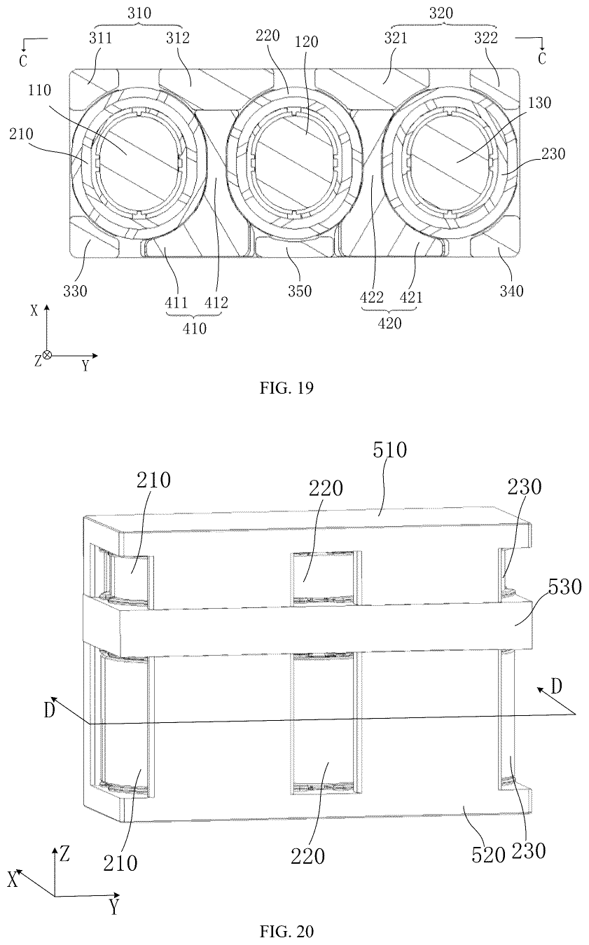

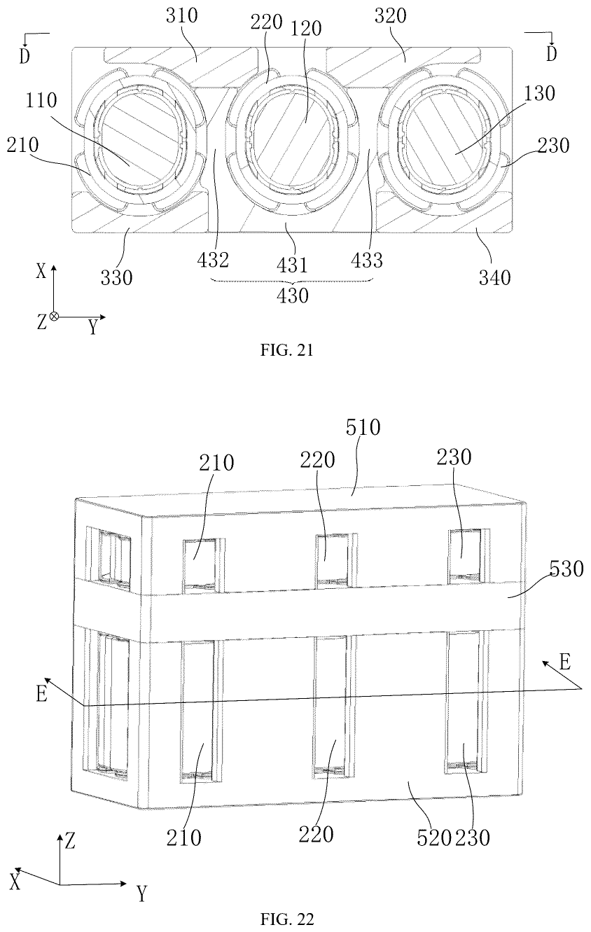

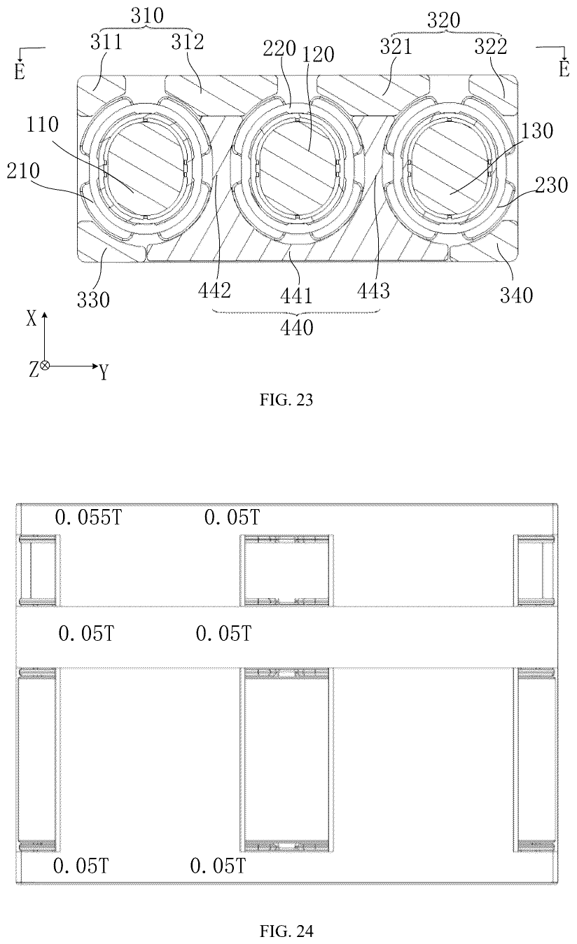

Among them, the A-A sectional view structure of the integrated magnetic device shown in FIG. 15 is consistent with the sectional view structure of the magnetic component shown in FIG. 5. The A-A sectional view structure of the integrated magnetic device shown in FIG. 17 is consistent with the sectional view structure of the magnetic component shown in FIG. 10. The A-A sectional view structure of the integrated magnetic device shown in FIG. 19 is consistent with the sectional view structure of the magnetic component shown in FIG. 11. The A-A sectional view structure of the integrated magnetic device shown in FIG. 21 is consistent with the sectional view structure of the magnetic component shown in FIG. 12. The A-A sectional view structure of the integrated magnetic device shown in FIG. 23 is consistent with the sectional view structure of the magnetic component shown in FIG. 13. This will not be described in detail in this embodiment.

It can be understood that in this embodiment, the structure of the aforementioned magnetic component is applied in the integrated magnetic device, this enables a uniform distribution of the magnetic circuits formed by the windings throughout the integrated magnetic device, thereby improving the magnetic flux cancellation effect and reducing the magnetic core losses of the magnetic component.

Continue to refer to FIG. 14 to FIG. 23, the embodiment further provides an integrated magnetic device. The integrated magnetic device includes the aforementioned magnetic component and a third core plate 530. The third core plate 530 is located between the first core plate 510 and the second core plate 520, that is, the first core plate 510, the third core plate 530 and the second core plate 520 are arranged at intervals in pairs in the third direction Z. The first winding 210 includes a first transformer winding and a first inductance winding. The first transformer winding and the first inductance winding are located at a first side and a second side of the third core plate 530 respectively. For example, the first transformer winding can be the first winding 210 located above the third core plate 530 as shown in figures, and the first inductance winding can be the first winding 210 located below the third core plate 530 as shown in figures. The second winding 220 includes a second transformer winding and a second inductance winding, the second transformer winding and the second inductance winding are located at the first side and the second side of the third core plate 530 respectively. For example, the second transformer winding can be the second winding 220 located above the third core plate 530 as shown in figures, and the second inductance winding can be the second winding 220 located below the third core plate 530 as shown in figures. The third winding 230 includes a third transformer winding and a third inductance winding, the third transformer winding and the third inductance winding are located at the first side and the second side of the third core plate 530 respectively. For example, the third transformer winding can be the third winding 230 located above the third core plate 530 as shown in figures, and the third inductance winding can be the third winding 230 located below the third core plate 530 as shown in figures.

The first side leg 310 includes a first upper side leg and a first lower side leg. For example, the first upper side leg can be the first side leg 310 located above the third core plate 530, and the first lower side leg can be the first side leg 310 located below the third core plate 530. The second side leg 320 includes a second upper side leg and a second lower side leg. For example, the second upper side leg can be the second side leg 320 located above the third core plate 530, and the second lower side leg can be the second side leg 320 located below the third core plate 530. The third side leg 330 includes a third upper side leg and a third lower side leg. For example, the third upper side leg can be the third side leg 330 located above the third core plate 530, and the third lower side leg can be the third side leg 330 located below the third core plate 530. The fourth side leg 340 includes a fourth upper side leg and a fourth lower side leg. For example, the fourth upper side leg can be the fourth side leg 340 located above the third core plate 530, and the fourth lower side leg can be the fourth side leg 340 located below the third core plate 530. It can be understood that the first upper side leg, the second upper side leg, the third upper side leg and the fourth upper side leg connect the first core plate 510 and the third core plate 530, while the first lower side leg, the second lower side leg, the third lower side leg and the fourth lower side leg connect the third core plate 530 and the second core plate 520.

In the embodiment, the first upper side leg, the second upper side leg, the third upper side leg, the fourth upper side leg, the first core plate 510, the third core plate 530, the first transformer winding, the second transformer winding, and the third transformer winding together form a transformer. The first lower side leg, the second lower side leg, the third lower side leg, the fourth lower side leg, the third core plate 530, the second core plate 520, the first inductor winding, the second inductor winding, and the third inductor winding together form an inductor. That is, the integrated magnetic device can include a transformer and an inductor formed on both sides of the third core plate 530.

It can be understood that in the embodiment, the structure of the aforementioned magnetic component is applied in the integrated magnetic device, this enables a uniform distribution of the magnetic circuits formed by the windings throughout the integrated magnetic device, thereby improving the magnetic flux cancellation effect and reducing the magnetic core losses of the magnetic component.

Table 2 shows results of magnetic core losses of the magnetic component in the embodiment of FIG. 5.

TABLE 2

| | The number of turns of the resonant | | | |
|---|---|---|---|---|
| | inductor (Nr) = 8; | | | |
| | Primary winding (Np): | | | |
| | Secondary winding (Ns) = | | | |
| | 12:6 (0.05*1200) | | | |
| | Output voltage 820 V | | | |
| | Input voltage 460 V | | Output voltage 680 V | |
| | (delay) | | Input voltage 275 V | |
| Resonant inductor | 18.238 | W | 28.694 | W |
| winding loss (Lr_W) | | | | |
| Resonant inductor core | 3.7661 | W*1.5 | 7.38 | W*1.5 |
| loss (Lr_Core) | | | | |
| Transformer winding | 39.103 | W | 65.71 | W |
| loss (Tx_W) | | | | |
| Transformer core loss | 6.687 | W*1.5 | 3.2619 | W*1.5 |
| (Tx_Core) | | | | |
| Total | 73.02 | W | 110.37 | W |

Table 3 shows results of magnetic core losses of the magnetic component in the embodiment of FIG. 11.

TABLE 3

| | The number of turns of the resonant | | | |
|---|---|---|---|---|
| | inductor (Nr) = 8; | | | |
| | Primary winding (Np): | | | |
| | Secondary winding (Ns) = | | | |
| | 12:6 (0.05*1200) | | | |
| | Output voltage 820 V | | | |
| | Input voltage 460 V | | Output voltage 680 V | |
| | (delay) | | Input voltage 275 V | |
| Resonant inductor | 18.238 | W | 28.694 | W |
| winding loss (Lr_W) | | | | |
| Resonant inductor core | 3.5232 | W*1.5 | 7.0232 | W*1.5 |
| loss (Lr_Core) | | | | |
| Transformer winding | 39.103 | W | 65.71 | W |
| loss (Tx_W) | | | | |
| Transformer core loss | 7.272 | W*1.5 | 3.28884 | W*1.5 |
| (Tx_Core) | | | | |
| Total | 72.041 | W | 109.87 | W |

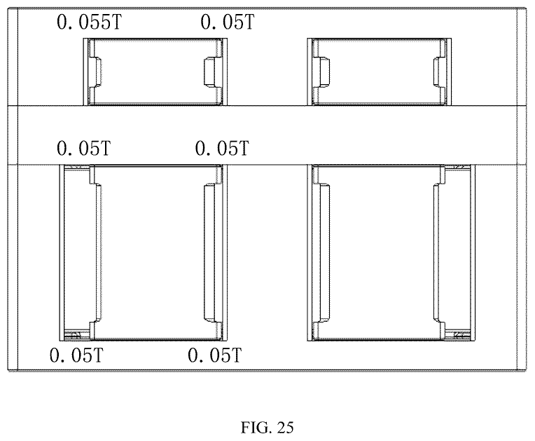

As can be seen from the above Table 2, FIG. 24, Table 3 and FIG. 25, the magnetic core losses of the magnetic components in the embodiments are small, so the magnetic core losses of the corresponding integrated magnetic devices are also small. In addition, the embodiment shown in FIG. 11 can further reduce the magnetic core losses of the magnetic component compared to that of the embodiment shown in FIG. 5.

The embodiment also provides a three-phase converter. The three-phase converter includes a first-side circuit and a second-side circuit, and further includes a magnetic component or an integrated magnetic device. The magnetic component or the integrated magnetic device is electrically connected between the first-side circuit and the second-side circuit. The magnetic component is the magnetic component in the aforementioned embodiments, and the integrated magnetic device is the integrated magnetic device in the aforementioned embodiments.

It can be understood that due to the adoption of the aforementioned magnetic component or integrated magnetic device, the three-phase converter of the embodiment has low magnetic core losses. This enhances the performance of the three-phase converter, improves its stability, and extends its service life. In some embodiments of the present application, the three-phase converter can be a three-phase resonant converter.

In the description of the present application, it should be understood that the orientation or position relationships indicated by the terms “center”, “longitudinal”, “transverse”, “length”, “width”, “thickness”, “up”, “down”, “front”, “rear”, “left”, “right”, “vertical”, “horizontal”, “top”, “bottom”, “inner”, “outer”, “clockwise”, “counterclockwise”, “axial”, “radial”, and “circumferential” etc., are based on the orientation or position relationships shown in the accompanying drawings, they are only for facilitating the description of the present application and simplifying the description, and do not indicate or imply that the device or element referred to must have a particular orientation, be constructed and operated in a particular orientation. Therefore, they cannot be understood as a limitation of the present application.

In the present application, unless otherwise explicitly defined and limited, terms such as “install”, “connect”, “couple” and “fix” etc., should be broadly understood. For example, they can refer to fixed connections, detachable connections, or integrated structures. They can be direct connections, indirect connections through an intermediary, internal interconnections of two components or interaction relationships between two components. For those skilled in the art, the specific meanings of the above terms in the present application can be understood according to the specific circumstances.

It should be noted that in the description of the present application, the terms “first” and “second” are used merely for the convenience of describing different components and should not be construed as indicating or implying an order relationship, relative importance, or implicitly specifying the number of technical features indicated. Therefore, features defined by “first” and “second” can explicitly or implicitly include at least one such feature.

The various embodiments or implementations in the present application are described in a progressive manner, with each embodiment focusing on the differences from other embodiments. The identical or similar parts among different embodiments can be referred to each other.

In the description of the present application, the reference terms “an implementation”, “some implementations”, “exemplary implementation”, “example”, “specific example”, or “some examples” indicate that the specific features, structures, materials, or characteristics described in conjunction with the implementation or example are included in at least one implementation or example of the present application. In the present application, the illustrative expressions of the above terms do not necessarily refer to the same implementation or example. Moreover, the described specific features, structures, materials, or characteristics can be combined in any one or more implementations or examples in a suitable manner.

Finally, it should be noted that the aforementioned embodiments are intended to illustrate the technical solutions of the present application, but not to intend to limit them. Notwithstanding the detailed description of the present application by reference to the foregoing embodiments, it should be understood to those skilled in the art that they can still modify the technical solutions described in the foregoing embodiments and equivalently replace some or all of the technical features thereof. Such modifications or replacements will not cause the essence of the corresponding technical solutions to depart from the scope of the technical solutions of the embodiments of the present application.

What is claimed is:

1. A magnetic component, comprising a first core plate and a second core plate arranged oppositely, wherein a first center leg, a second center leg and a third center leg are arranged between the first core plate and the second core plate, and along a second direction, the second center leg is placed between the first center leg and the third center leg, wherein the first center leg is wound around a first winding, the second center leg is wound around a second winding, and the third center leg is wound around a third winding;
the magnetic component further comprises a plurality of side legs connecting the first core plate and the second core plate, wherein the plurality of side legs comprise a first side leg, a second side leg, a third side leg, and a fourth side leg; along a first direction, the first side leg and the second side leg are located at a first side of the first winding, the second winding and the third winding; wherein the third side leg and the fourth side leg are located at a second side of the first winding, the second winding and the third winding;
wherein along the second direction, a first side of the first center leg is close to the third center leg, and a second side of the first center leg is away from the third center leg; a first side of the third center leg is away from the first center leg, and a second side of the third center leg is close to the first center leg; wherein the first side leg and the second side leg are arranged at intervals, a part of the first side leg is located between the first center leg and the second center leg, while another part of the first side leg is located at a side of the part of the first side leg away from the third center leg; wherein a part of the second side leg is located between the second center leg and the third center leg, while another part of the second side leg is located at a side of the part of the second side leg away from the first center leg; wherein the third side leg and the fourth side leg are arranged at intervals, with at least part of the third side leg located at the second side of the first center leg, and at least part of the fourth side leg located at the first side of the third center leg.

2. The magnetic component according to claim 1, wherein along the second direction, a first end of the first side leg is close to the second center leg; a second end of the first side leg extends to an end of the first center leg away from the third center leg;
wherein along the second direction, a second end of the second side leg is close to the second center leg; a first end of the second side leg extends to an end of the third center leg away from the first center leg.

3. The magnetic component according to claim 1, wherein the first side leg comprises a first sub-side leg and a second sub-side leg, wherein along the second direction, the second sub-side leg is at least located between the first center leg and the second center leg, the first sub-side leg is located at the second side of the first center leg;
wherein the second side leg comprises a third sub-side leg and a fourth sub-side leg, wherein along the second direction, the third sub-side leg is at least located between the second center leg and the third center leg, the fourth sub-side leg is located at the first side of the third center leg.

4. The magnetic component according to claim 1, further comprising a fifth side leg;
wherein along the second direction, the third side leg, the fourth side leg and the fifth side leg are arranged at intervals; wherein along the first direction, the fifth side leg is located at the second side of the first winding, the second winding and the third winding; wherein in a plane perpendicular to the first direction, a projection of the third side leg is within a projection range of the first winding, a projection of the fifth side leg is within a projection range of the second winding, and a projection of the fourth side leg is within a projection range of the third winding.

5. The magnetic component according to claim 4, wherein along the second direction, the third side leg is located at the second side of the first center leg, and the fourth side leg is located at the first side of the third center leg.

6. The magnetic component according to claim 5, further comprising a first heatsink and a second heatsink, wherein the first heatsink comprises a first sub-heatsink and a second sub-heatsink, wherein the second sub-heatsink is connected to a first end of the first sub-heatsink, and the first end of the first sub-heatsink is close to the fifth side leg; wherein the second heatsink comprises a third sub-heatsink and a fourth sub-heatsink, wherein the fourth sub-heatsink is connected to a second end of the third sub-heatsink, and the second end of the third sub-heatsink is close to the fifth side leg;
wherein along the second direction, the first sub-heatsink is located between the third side leg and the fifth side leg, the second sub-heatsink is located between the first winding and the second winding, the third sub-heatsink is located between the fifth side leg and the fourth side leg, and the fourth sub-heatsink is located between the second winding and the third winding.

7. The magnetic component according to claim 2, wherein in a plane perpendicular to the first direction, a projection of the third side leg is within a projection range of the first winding, and a projection of the fourth side leg is within a projection range of the third winding.

8. The magnetic component according to claim 3, wherein in a plane perpendicular to the first direction, a projection of the third side leg is within a projection range of the first winding, and a projection of the fourth side leg is within a projection range of the third winding.

9. The magnetic component according to claim 7, further comprising a third heatsink, wherein the third heatsink comprises a fifth sub-heatsink, a sixth sub-heatsink and a seventh sub-heatsink;
wherein along the second direction, the sixth sub-heatsink and the seventh sub-heatsink are respectively connected to two ends of the fifth sub-heatsink, wherein the fifth sub-heatsink is located between the third side leg and the fourth side leg, the sixth sub-heatsink is located between the first winding and the second winding, and the seventh sub-heatsink is located between the second winding and the third winding.

10. The magnetic component according to claim 8, further comprising a third heatsink, wherein the third heatsink comprises a fifth sub-heatsink, a sixth sub-heatsink and a seventh sub-heatsink;
wherein along the second direction, the sixth sub-heatsink and the seventh sub-heatsink are respectively connected to two ends of the fifth sub-heatsink, wherein the fifth sub-heatsink is located between the third side leg and the fourth side leg, the sixth sub-heatsink is located between the first winding and the second winding, and the seventh sub-heatsink is located between the second winding and the third winding.

11. The magnetic component according to claim 2, further comprising a fourth heatsink, wherein the fourth heatsink comprises an eighth sub-heatsink, a ninth sub-heatsink and a tenth sub-heatsink;
wherein along the second direction, the ninth sub-heatsink and the tenth sub-heatsink are respectively connected to the eighth sub-heatsink, wherein the eighth sub-heatsink is located between the third side leg and the fourth side leg, the ninth sub-heatsink is located between the first winding and the second winding, the tenth sub-heatsink is located between the second winding and the third winding;
wherein the third side leg is located at the second side of the first center leg, and the fourth side leg is located at the first side of the third center leg; wherein in a plane perpendicular to the first direction, a projection of the eighth sub-heatsink is within a projection range of at least one of the first winding or the third winding.

12. The magnetic component according to claim 3, further comprising a fourth heatsink, wherein the fourth heatsink comprises an eighth sub-heatsink, a ninth sub-heatsink and a tenth sub-heatsink;
wherein along the second direction, the ninth sub-heatsink and the tenth sub-heatsink are respectively connected to two ends of the eighth sub-heatsink, wherein the eighth sub-heatsink is located between the third side leg and the fourth side leg, the ninth sub-heatsink is located between the first winding and the second winding, the tenth sub-heatsink is located between the second winding and the third winding;
wherein the third side leg is located at the second side of the first center leg, and the fourth side leg is located at the first side of the third center leg; wherein in a plane perpendicular to the first direction, a projection of the eighth sub-heatsink is within a projection range of at least one of the first winding or the third winding.

13. An integrated magnetic device, comprising the magnetic component according to claim 1 and a third core plate; wherein the third core plate is located between the first core plate and the second core plate; wherein the first winding comprises a first upper winding and a first lower winding, the first upper winding and the first lower winding are located at a first side and a second side of the third core plate respectively; wherein the second winding comprises a second upper winding and a second lower winding, the second upper winding and the second lower winding are located at the first side and the second side of the third core plate respectively; wherein the third winding comprises a third upper winding and a third lower winding, the third upper winding and the third lower winding are located at the first side and the second side of the third core plate respectively.

14. The integrated magnetic device according to claim 13, wherein along the second direction, a first end of the first side leg is close to the second center leg; a second end of the first side leg extends to an end of the first center leg away from the third center leg;
wherein along the second direction, a second end of the second side leg is close to the second center leg; a first end of the second side leg extends to an end of the third center leg away from the first center leg.

15. The integrated magnetic device according to claim 13, wherein the first side leg comprises a first sub-side leg and a second sub-side leg, wherein along the second direction, the second sub-side leg is at least located between the first center leg and the second center leg, the first sub-side leg is located at the second side of the first center leg;
wherein the second side leg comprises a third sub-side leg and a fourth sub-side leg, wherein along the second direction, the third sub-side leg is at least located between the second center leg and the third center leg, the fourth sub-side leg is located at the first side of the third center leg.

16. The integrated magnetic device according to claim 13, wherein the first upper winding is a first transformer winding, the first lower winding is a first inductance winding; wherein the second upper winding is a second transformer winding, the second lower winding is a second inductance winding; the third upper winding is a third transformer winding, the third lower winding is a third inductance winding.

17. The integrated magnetic device according to claim 16, wherein the first side leg comprises a first upper side leg and a first lower side leg, the second side leg comprises a second upper side leg and a second lower side leg, the third side leg comprises a third upper side leg and a third lower side leg, and the fourth side leg comprises a fourth upper side leg and a fourth lower side leg, wherein the first upper side leg, the second upper side leg, the third upper side leg, and the fourth upper side leg are connected to the first core plate and the third core plate, the first lower side leg, the second lower side leg, the third lower side leg, and the fourth lower side leg are connected to the third core plate and the second core plate;
wherein the first upper side leg, the second upper side leg, the third upper side leg, the fourth upper side leg, the first core plate, the third core plate, the first transformer winding, the second transformer winding, and the third transformer winding together form a transformer; wherein the first lower side leg, the second lower side leg, the third lower side leg, the fourth lower side leg, the third core plate, the second core plate, the first inductor winding, the second inductor winding, and the third inductor winding together form an inductor.

18. A three-phase converter, comprising a first-side circuit and a second-side circuit, and further comprising a magnetic component, wherein the magnetic component is electrically connected between the first-side circuit and the second-side circuit, wherein the magnetic component employs the magnetic component according to claim 1.

19. The three-phase converter according to claim 18, further comprising a third core plate;
wherein the third core plate is located between the first core plate and the second core plate; wherein the first winding comprises a first upper winding and a first lower winding, the first upper winding and the first lower winding are located at a first side and a second side of the third core plate respectively; wherein the second winding comprises a second upper winding and a second lower winding, the second upper winding and the second lower winding are located at the first side and the second side of the third core plate respectively; wherein the third winding comprises a third upper winding and a third lower winding, the third upper winding and the third lower winding are located at the first side and the second side of the third core plate respectively.
